(19) United States
(12) Patent Application Publication
(10) Pub. No.: US 2005/0263120 A1
(43) Pub. Date: Dec. 1, 2005

(54) System and methods for remote control of a motor vehicle and theft prevention

(76) Inventors: Jacob W. Fifelski, Wayland, MI (US); Vernon A. Bellgrath, Wayland, MI (US); Michael J. J. Karlesky, Grand Rapids, MI (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 11/125,672

(22) Filed: May 10, 2005

Related U.S. Application Data
(60) Provisional application No. 60/569,494, filed on May 10, 2004.

(51) Int. Cl. F02N 17/00

(52) U.S. Cl. 123/179.2

(57) ABSTRACT

A remote control system for a motor vehicle uses a wide area network to enable a starter on the motor vehicle. A user uses a communication device, such as a telephone, to send instructions to the starter by way of the wide area network. A controller enables or disables various components within the motor vehicle. To further enhance the utility of the remote control system, the system can disable the operation of the motor vehicle by disabling the fuel pump on the motor vehicle. In order to reduce the likelihood of an accident, disabling of the fuel pump occurs only after a signal, such as a tachometer signal, indicates that it is safe to disable the fuel pump.

This application claims the benefit of Provisional Application No. 60/569,494 filed on May 10, 2004.

### BACKGROUND OF THE INVENTION

Remote starting of motor vehicles is desirable. Thus, many motor vehicle owners equip their motor vehicle with an aftermarket remote starter.

Conventionally, an aftermarket remote starter is operated with a key fob. A user in proximity to the motor vehicle depresses a button on a transmitter. An FM (frequency modulated) signal is sent to a starter in the vehicle. While such a system is effective at starting the automobile, there are problems.

Such a transmitter has a limited range. Theoretically, the range of such a signal could be in excess of one thousand (1000) feet. Obstructions such as concrete and metal walls reduce the effective range of the transmitter. Since motor vehicles are often parked with many other motor vehicles in parking lots, the interference from these other automobiles further effects the range: Thus, for some users, the effective range of such a remote starter is insufficient.

To overcome these problems, attempts have been made to use paging networks to remote start a vehicle. One such system is shown in U.S. Pat. No. 6,480,098 entitled “Remote Vehicle Control System including Common Carrier Paging Receiver and Related Methods”, issued to Kenneth Flick and assigned to Omega Patents. A signal to start the automobile is received by the paging receiver. The paging receiver then activates a wireless transmitter within the automobile. The wireless transmitter sends a signal to the remote starter. While such a system does increase the range of the remote starting system, the additional transmitter within the motor vehicle increases the complexity of an aftermarket installation of the system. Further, due to the proximity of the transmitter to the electrical systems of the automobile, there is an increased risk for interference.

Some remotely operable devices provide for disabling the motor vehicle if the vehicle is stolen. If the vehicle is disabled at an inopportune time, such as when the vehicle is being driven on a crowded street, the vehicle could be damaged or the safety of others could be jeopardized.

An improved starter system with an improved theft prevention system which overcomes the above mentioned problems is highly desirable.

### SUMMARY OF THE INVENTION

A remote control system for a motor vehicle engine has a wireless receiver; and a controller directly connected to a starter control unit. The motor vehicle tachometer is coupled to the controller by way of a tachometer signal conditioning circuit coupled between the tachometer and the controller. A hood switch indicator and a fuel pump are also coupled to the controller.

The remote control system disables the fuel pump in response to a message received by the receiver. Prior to disabling the fuel pump, a signal from the tachometer signal is used to determine if the engine is running. If the engine is not running, then the fuel pump is disabled.

The operation of the remote control system consists of receiving a message from a wide area network and validating a passcode contained within the message. If the passcode is valid, the message is parsed and the command is performed.

Prior to performing the command, one or more system parameters may be detected to insure that the command can be safely executed.

These and other objects, advantages and features of the invention will be more readily understood and appreciated by reference to the detailed description of the drawings.

### BRIEF DESCRIPTION OF THE DRAWINGS

FIG. 1 shows the general operation of the device.

FIG. 2 is a block diagram of a remote control system.

FIG. 3 is a flow chart for operation of the system.

FIG. 4 shows such a method using the heretofore described system.

FIG. 5 shows a tachometer conditioning circuit for use with the system described herein.

### DETAILED DESCRIPTION OF THE DRAWINGS

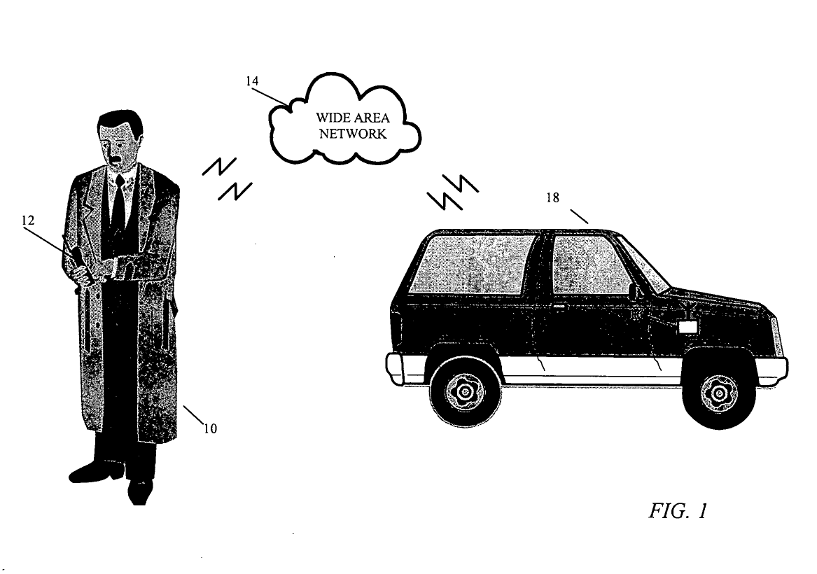

FIG. 1 shows the general operation of the device. A user 10 utilizes a communication device 12 to communicate with wide area network 14. Communication device 12 could be a conventional telephone, a cellular telephone, a Blackberry, a computer or any other similar device. Wide area network 14 could be based on FLEX, SMS (Short Message Service), POCSAG, or any other type of a wireless wide area network. Wide area network could also be a cellular voice network. A message sent from communication device 12 is received by wireless control unit 16. Wireless control unit 16 then actuates various devices within motor vehicle 18.

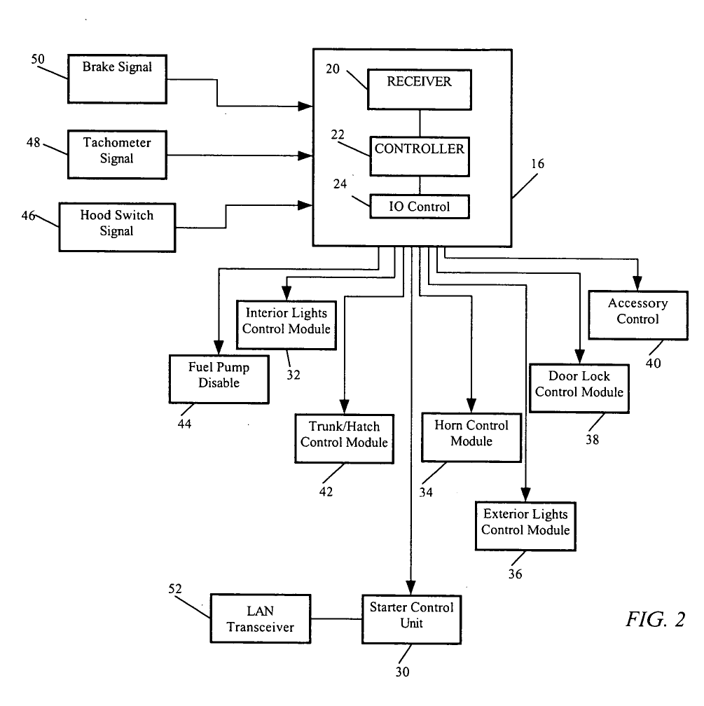

FIG. 2 is a block diagram of a remote control system for a motor vehicle. Wireless control unit 16 includes receiver 20 and controller 22. Wide area network 14 sends messages to receiver 20. Receiver 20 could be any type of receiver, such as digital cellular, analog cellular, or a frequency modulated. Receiver 20 could also operate include capabilities to interoperate with a Bluetooth or WIFI transmission device. The output of receiver 20 is provided to controller 22. Controller 22 could be any suitable microcontroller or microprocessor.

IO control 24 handles communication between controller 22 and the various devices. If controller 22 had sufficient configurable outputs, then IO control 24 would be optional.

IO control 24 manages the communication between wireless control unit 16 and a variety of different devices within the motor vehicle. Starter control unit 30 is an aftermarket starter unit specifically designed to start the particular motor vehicle. Controller 22 is directly connected to a pulse-to-start or a trigger-to-start input of starter control unit 30. Starter control unit 30 could be one of the types referred to as an “add-on” starter.

Interior light control module 32 turns on and off the interior lights of the motor vehicle. Horn control module 34 actuates the horn. The motor vehicle exterior lights are controlled by exterior light control module 36, while door lock control module 38 actuates the locks. Accessory control 40 is for any other accessories within the motor vehicle. Trunk latch control module 42 enables the operation of the trunk latch. Fuel pump disable 44 allows the disabling of the fuel pump of the motor vehicle.

Wireless control unit 16 also has several inputs from the motor vehicle. Hood switch indicator 46 shows whether the hood has been opened. Tachometer signal 48 provides the speed of the motor vehicle engine. Brake signal 50 is a signal indicating whether the brakes have been activated.

Starter control unit 30 is connected to LAN (local area network) receiver 52. LAN receiver 52 could be a conventional FM or AM receiver. Additionally, LAN receiver 52 could include a Bluetooth or WIFI receiver. LAN receiver 52 could also be a transceiver. Communication device 12 could include a transmitter adapted to be received by LAN receiver 52. Alternatively, a separate device could be used to access LAN receiver 52.

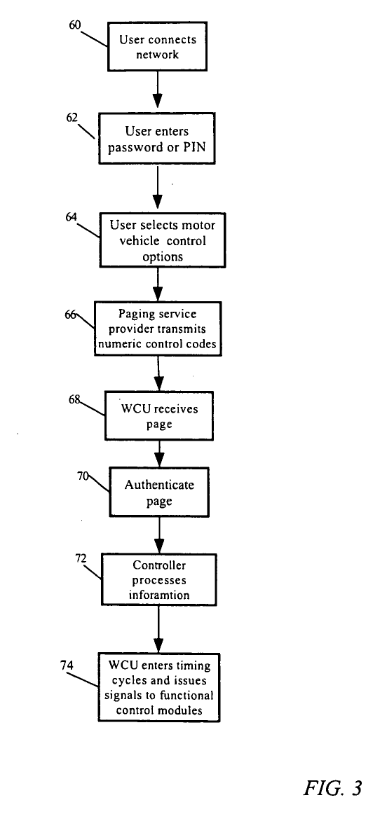

FIG. 3 is a flow chart for operation of the system. The flow chart is executed by controller 22 in conjunction with the operations of the various control modules. Code units within the flow chart are processed by controller 22. A user first connects with the network. Step 60. The user sends a vehicle identifier and a passcode. Step 62. The user then selects the various motor vehicle control options. Step 64.

If the user were connecting by telephone, then the vehicle identifier could be the telephone number associated with receiver 20. Alternatively, the vehicle identifier could be any combination of numbers and letters indicative of a specific vehicle. The passcode is a user selectable passcode, which again could be a combination of letters and numbers.

The wireless network receives the information and transmits it to the motor vehicle. Step 66. Optionally, the network provider could authenticate the message prior to transmission. The WCU receives the page. Step 68. The WCU authenticates the page. Step 70. The controller then processes the page. Step 72. The WCU then enters the appropriate timing cycles and issues the appropriate signals to the control modules.

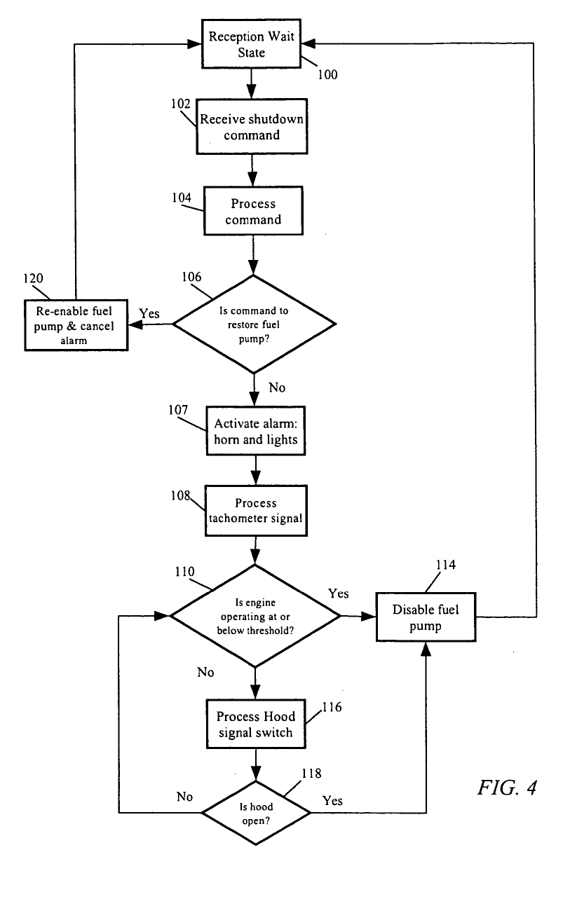

One additional feature of the system is the ability to disable the operation of the motor vehicle. FIG. 4 shows such a method using the heretofore described system.

The vehicle is waiting to receive a signal. Step 100. When a shutdown command is received (step 102), the command is processed. Step 104. The command is interpreted to determine if it is a restore fuel pump command. Step 106.

If it is not, then the alarm is activated. Step 107. This could include sounding the horn, flashing the interior and exterior lights, or activating any other device. The tachometer signal is processed. Step 108.

From the tachometer signal, the system determines whether the engine was operating at or below a desired speed threshold. Step 110. The speed threshold could be zero, for example if the engine needed to be off prior to disabling the fuel pump. Alternatively, the speed threshold could be at some minimal amount indicating little or no motion by the motor vehicle. The threshold is an indicator as to whether the motor vehicle can be safely disabled. If the engine is operating at or below the threshold, then the fuel pump is disabled. Step 114. The system then waits for further commands. Step 100.

If the engine is not operating at or below the threshold, the hood signal switch is processed. Step 116. If the hood is open, then the fuel pump is disabled. Therefore, under any circumstance, the fuel pump will be disabled if the hood is opened. When a thief opens the hood in order to disable the horn or siren, then the motor vehicle is disabled. If the hood is not open, then the system continues to check as to whether the threshold is met. Step 110.

In order to disable the vehicle, the system could also disable the ignition circuitry of the motor vehicle.

Instead of monitoring the tachometer, the system could monitor a vehicle speed sensor. In this situation, if the speed of the vehicle dropped below a predetermined level, then the fuel pump would be disabled.

Receivers 20, 52 could be transceivers. If so, then controller 22 could receive information on the status of the various devices within the motor vehicle and transmit that information over the network to a user. Controller 22 could be coupled to the central processor for the motor vehicle and could thereby provide extensive information about the operation of the vehicle such as temperature, door lock status, or alarm activation. If a cellular communication device were used, then GPS and location information could also be transmitted.

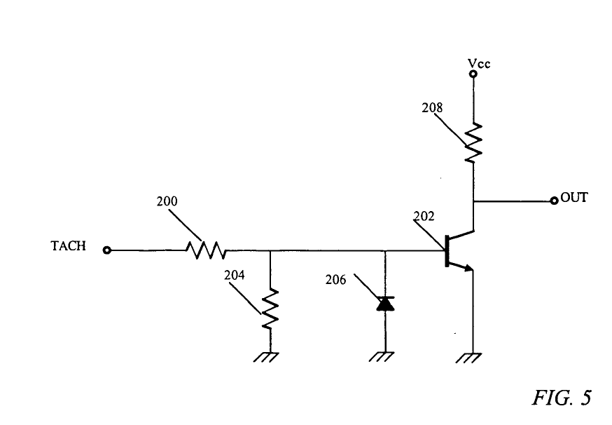

FIG. 5 shows a tachometer signal conditioning circuit for use with the system described herein. The circuit input, hereinafter referred to as TACH, comes from an engine control computer, an ignition coil or a fuel injector. Resistor 200 limits the current flow and prevents damage to transistor 202 in the event of voltage spikes from the ignition coil. Resistor 204 ensures the transistor 202 is off if the TACH signal is unconnected. Diode 206 protects transistor 202 from voltage spikes that may reverse-bias the emitter-base junction of the transistor 202.

When the TACH signal is at or near GND, transistor 202 is off and does not conduct current. Pull-up resistor 208 maintains a voltage level for OUT at or near Vcc when transistor 202 is off.

When the TACH signal is of sufficient voltage (approximately 2 volts) to turn on transistor 202, transistor 202 turns on, reducing the voltage at OUT to GND.

The change in voltage levels is interpreted by the microcontroller as a digital signal. The frequency of this digital signal will be directly equivalent to the frequency of transition of the TACH signal from GND to some positive voltage above 2 volts. Input capture circuitry on the microcontroller records the times at which the OUT signal changes from one level to another. Software on the microcontroller uses the difference in these times to estimate the period of the signal, thus the frequency (the reciprocal of the period). Averaging the period over several sample periods improves the accuracy of the algorithm.

The above description is of the preferred embodiment. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

1. A remote control system for a motor vehicle engine comprising:
a first wireless receiver for receiving communication over a first network;
a controller for receiving communication from the first wireless receiver, the controller directly connected to a starter; and
a second wireless receiver for receiving communication over a second network, the second wireless receiver coupled to the starter.

2. The remote control system of claim 1 further comprising:
a tachometer coupled to the controller.

3. The remote control system of claim 2 further comprising:
a hood switch indicator coupled to the controller.

4. The remote control system of claim 3 further comprising:
a fuel pump coupled to the controller.

5. The remote control system of claim 4 further comprising:
a first code unit for disabling the fuel pump in response to a message received by the first wireless receiver.

6. The remote control system of claim 5 further comprising:
a second code unit for disabling the fuel pump only if a tachometer signal is below a threshold.

7. The remote control system of claim 6 further comprising:
a tachometer signal conditioning circuit coupled between the tachometer and the controller.

8. The remote control system of claim 7 where the tachometer signal conditioning circuit includes a first transistor for providing an output to the controller.

9. A method of operating a remote starting system for a motor vehicle comprising:
receiving a message from a messaging system;
validating a passcode contained within the message;
if the passcode is valid, parsing the message into a command; and
performing the command.

10. The method of claim 9 further comprising:
prior to performing the command, detecting one or more system parameters to insure that the command can be safely executed.

11. A method of remotely disabling a motor vehicle comprising:
receiving a message from a messaging system;
determining whether it is safe to disable the motor vehicle; and
if it is safe to disable the motor vehicle, then disabling the motor vehicle.

12. The method of claim 11 where the motor vehicle has an engine, and the step of determining whether it is safe to disable the motor vehicle comprises:
determining whether the engine is operating.

13. The method of claim 12 where the step of determining whether the engine is operating comprises one of:
reading a tachometer signal from a tachometer, the tachometer coupled to the engine and
reading a motor vehicle speed signal.

14. The method of claim 13 further comprising:
determining if a motor vehicle hood is open; and
if the motor vehicle hood is open, then disabling the motor vehicle.

15. The method of claim 14 where disabling the motor vehicle comprises:
disabling a fuel pump on the motor vehicle.

16. The method claim 15 where the step of disabling the motor vehicle comprises:
activating an alarm.
